(19) United States
(12) Patent Application Publication
(10) Pub. No.: US 2017/0018885 A1
(43) Pub. Date: Jan. 19, 2017

(54) CABLE CONNECTOR ASSEMBLY WITH A PRINTED CIRCUIT BOARD CONNECTING TO A PART OF CONTACTS THEREOF

(71) Applicant: FOXCONN INTERCONNECT TECHNOLOGY LIMITED, Grand Cayman (KY)

(72) Inventors: DA-WEI XING, Kunshan (CN); JUN CHEN, Kunshan (CN); JERRY WU, Irvine, CA (US)

(21) Appl. No.: 15/210,855

(22) Filed: Jul. 14, 2016

(30) Foreign Application Priority Data
Jul. 14, 2015 (CN) 201510409401.7

(51) Int. Cl. H01R 13/66; H01R 13/504

(52) U.S. Cl. CPC H01R 13/665; H01R 13/504

(57) ABSTRACT

A cable connector assembly including: an insulative housing; a number of first and second contacts retained to the insulative housing; a spacer assembled on a rear end of the insulative housing; a printed circuit board (PCB) electrically connected with the first contacts; and a cable including a number of first wires electrically connected with the PCB and a number of second wires directly electrically connected with the second contacts.

### BACKGROUND OF THE INVENTION

1. Field of the Invention

The present invention relates to a cable connector assembly, and more particularly to a cable connector assembly with a printed circuit board connecting to only certain contacts thereof.

2. Description of Related Art

U.S. Pat. No. 7,559,805, issued on Jul. 14, 2009, discloses a plug connector including an internal printed circuit board interconnected between a plurality of contacts and a plurality of cable wires.

### BRIEF SUMMARY OF THE INVENTION

According to one aspect of the present invention, a cable connector assembly comprises: an insulative housing; a plurality of first and second contacts retained to the insulative housing; a spacer assembled on a rear end of the insulative housing; a printed circuit board (PCB) electrically connected with the plurality of first contacts; and a cable including a plurality of first wires electrically connected with the PCB and a plurality of second wires directly electrically connected with the plurality of second contacts.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective assembled view of a cable connector assembly according to the present invention;

FIG. 2 is a partly exploded view of the cable connector assembly shown in FIG. 1;

FIG. 3 is a partly exploded view similar to the FIG. 2, but from a different perspective;

FIG. 4 is an assembly view of the contacts, the spacer and the printed circuit board of the cable connector assembly shown in FIG. 1;

FIG. 5 is an assembly view similar to FIG. 4, but from a different perspective;

FIG. 6 is an exploded view of a part of the cable connector assembly shown in FIG. 1; and

FIG. 7 is an exploded view similar to FIG. 6, but from a different perspective.

FIG. 8 is a side view of a part of the cable connector assembly of FIG. 1 to show the relation among the printed circuit board, the wires and the rear connecting sections of the contacts.

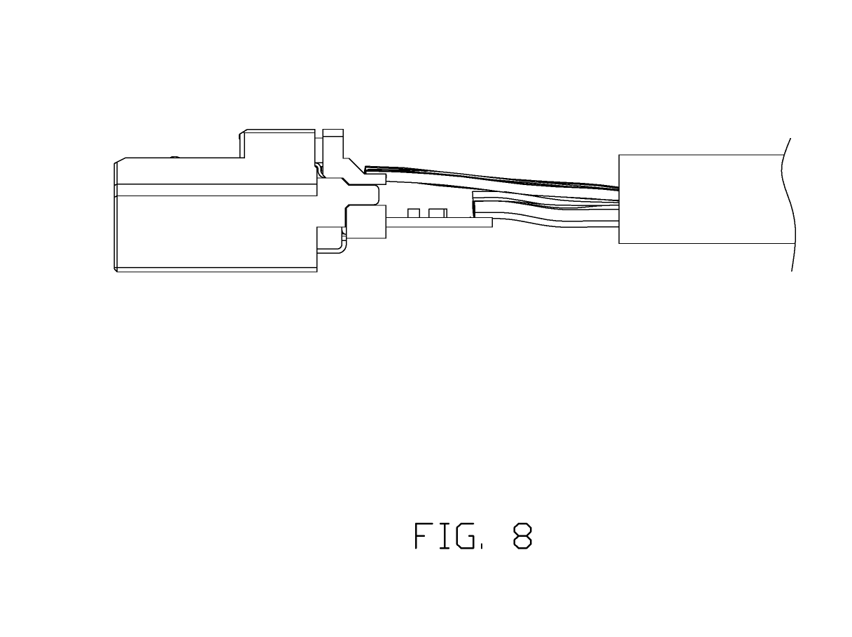

### DETAILED DESCRIPTION OF THE PREFERRED EMBODIMENT

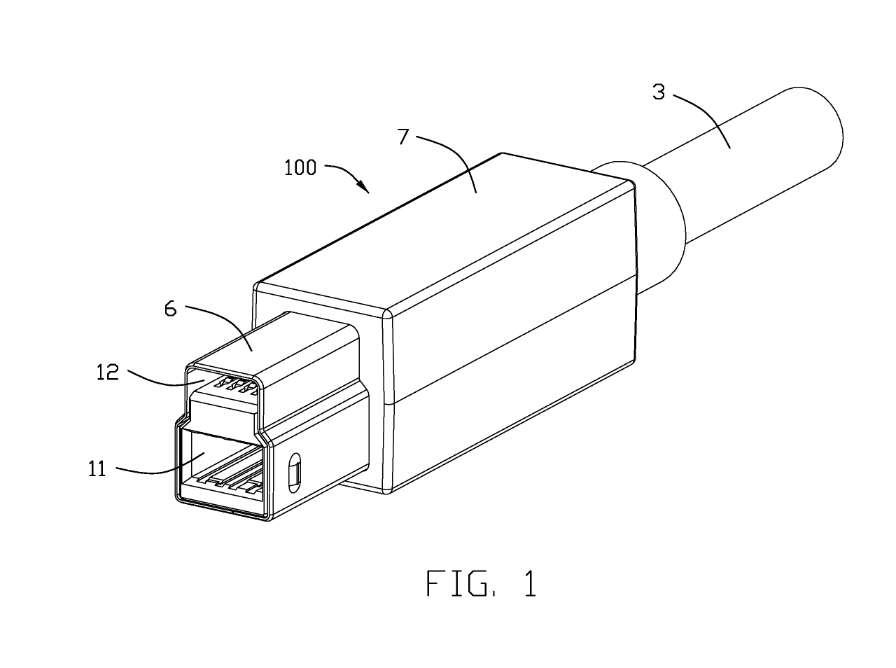

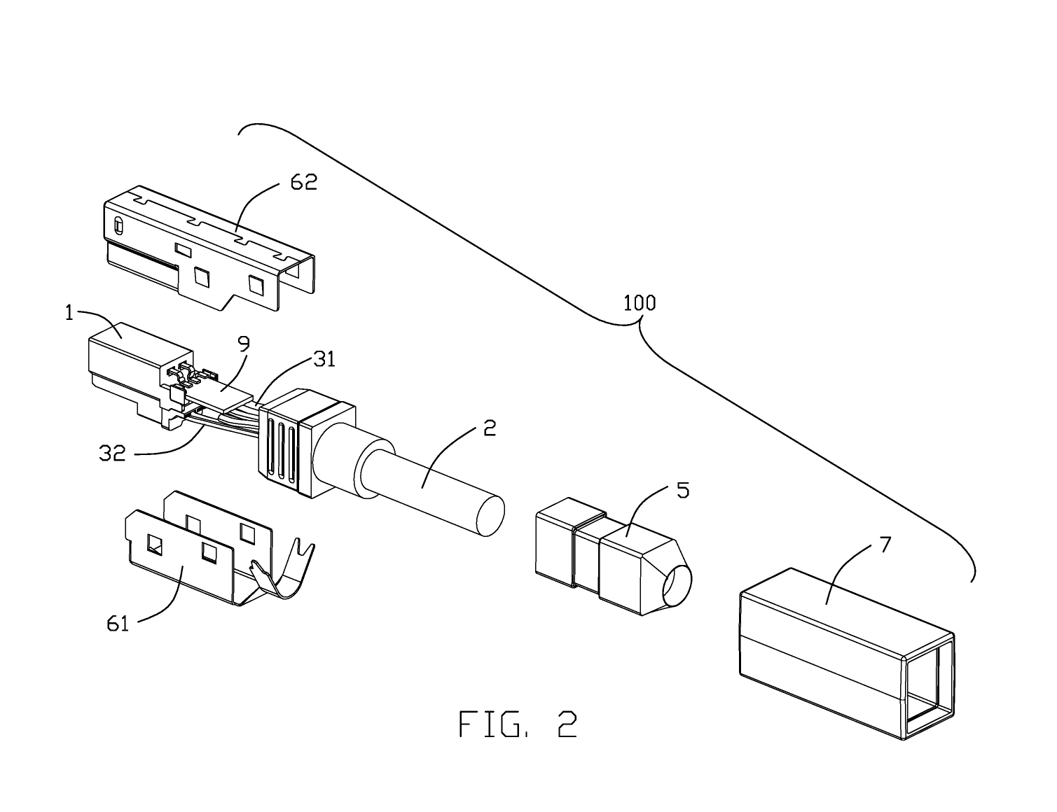

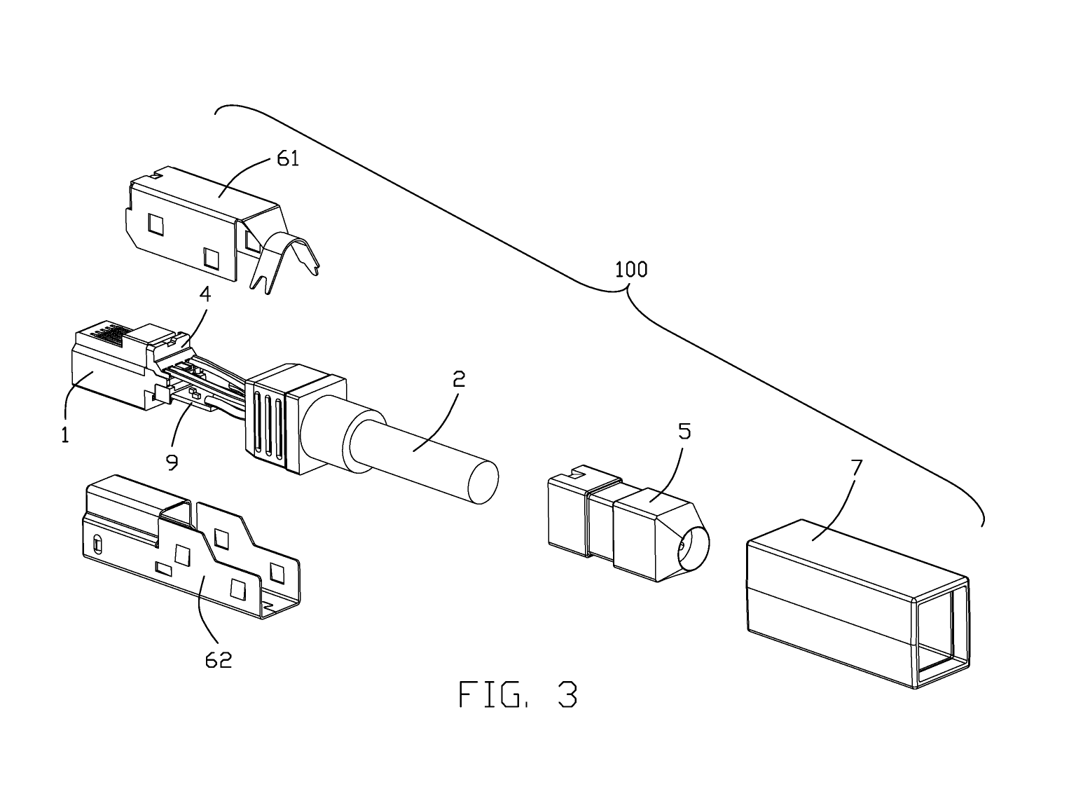

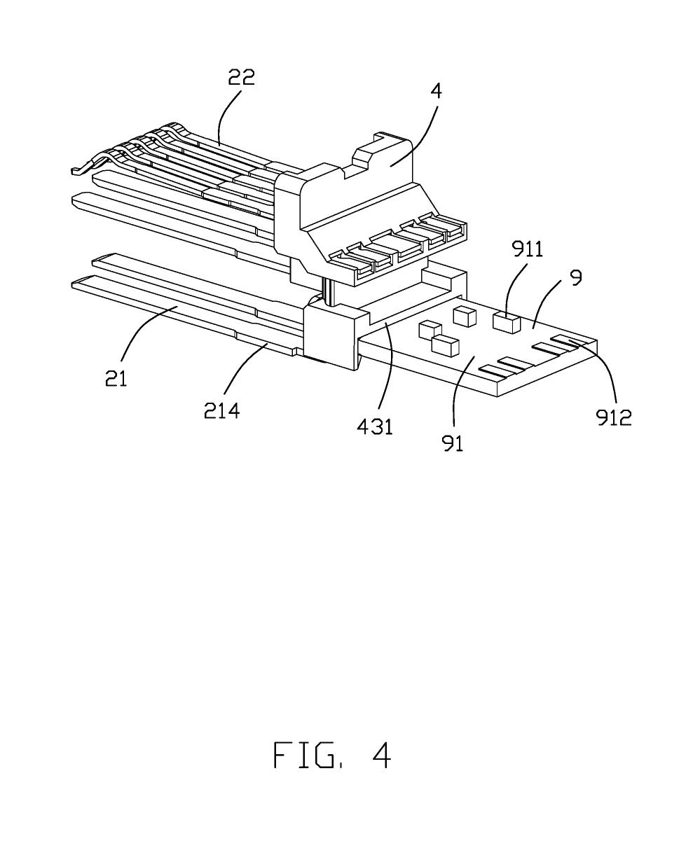

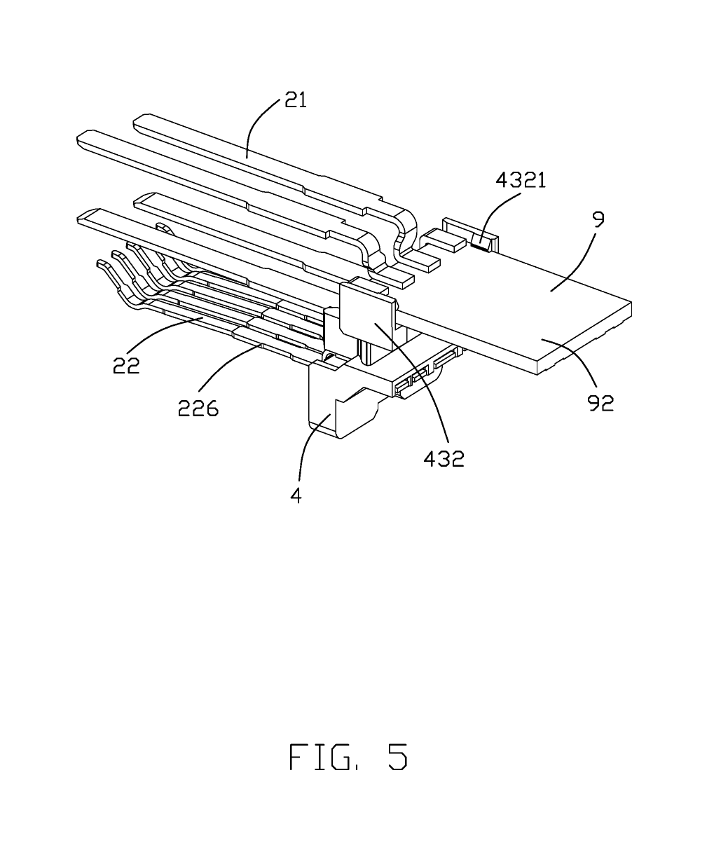

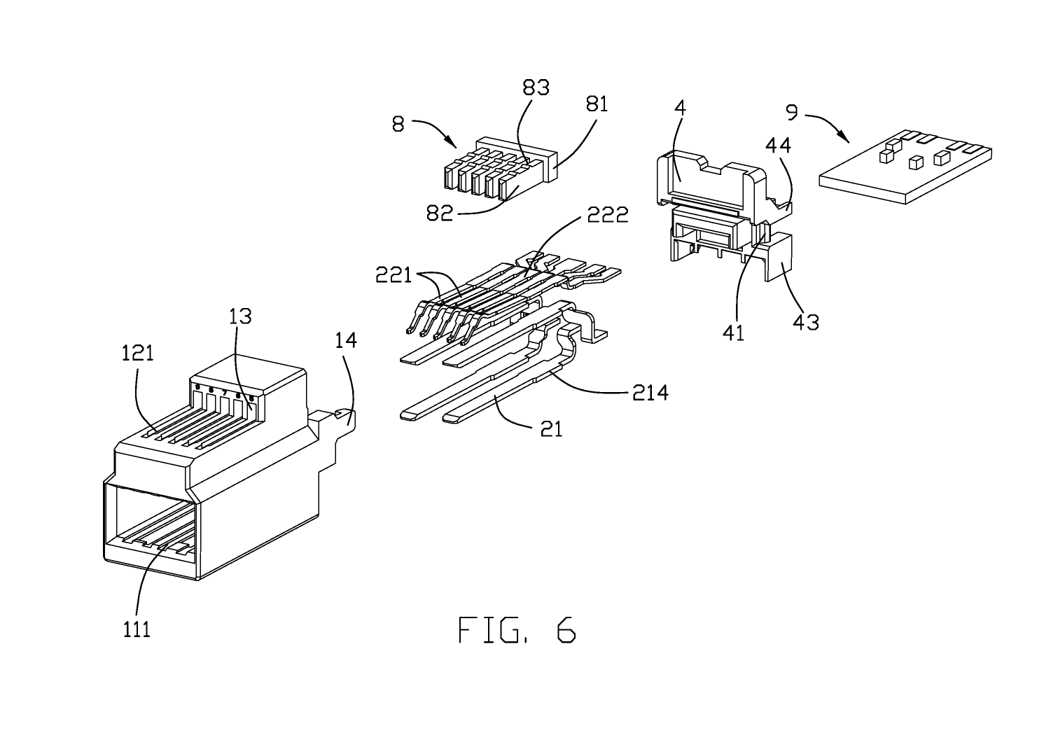

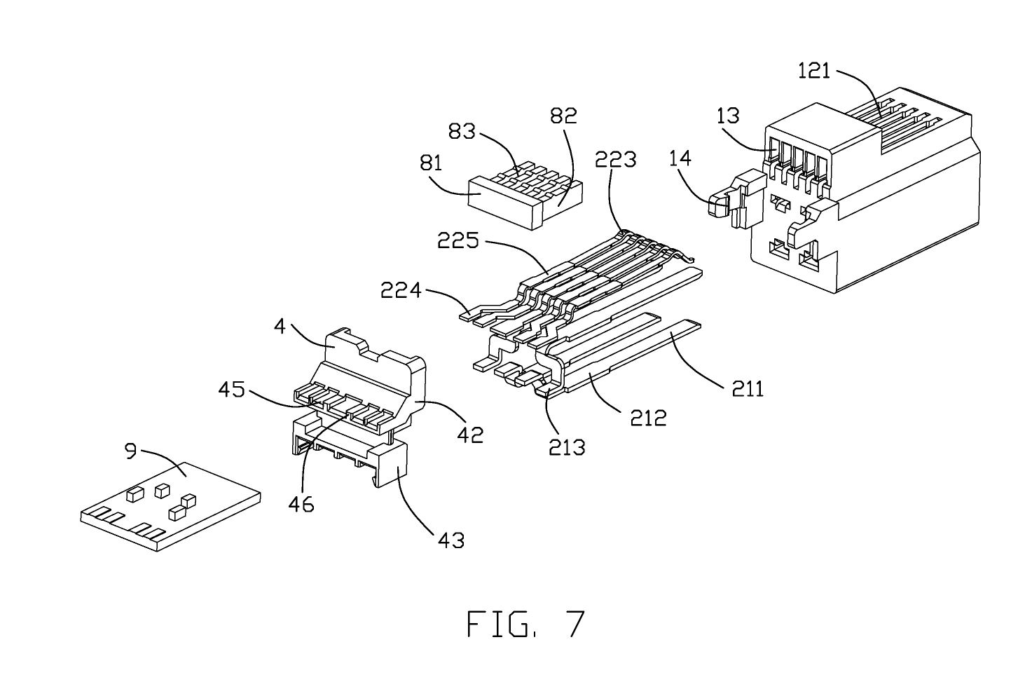

Referring to FIGS. 1-7, a cable connector assembly 100 according to a preferred embodiment of the present invention includes an insulative housing 1, a plurality of contacts 2 retained in the insulative housing 1, a cable 3 electrically connected with the contacts 2, a spacer 4 assembled on a rear end of the insulative housing 1, an insulative member 5 integrally molded on the rear end of the insulative housing 1 and a front end of the cable 3, a shielding case 6 enclosing the insulative housing 1 and a cover member 7 covering the shielding case 6. In the present embodiment, the cable connector assembly 100 is USB-B connector. The contacts 2 includes a plurality of first contacts 21 for transmitting low-frequency signals and a plurality of second contacts 22 for transmitting high-frequency signals.

The first contacts 21 transmits standard signal in accordance with USB 2.0 standard, including four contacts. Each of the first contacts 21 includes a plate-shaped front contacting portion/section 211, a fixing portion 212 rearwardly extending from the contacting portion 211 and a rear soldering portion or connecting section 213 disposed on a trailing end thereof. The fixing portion 212 defines a plurality of projecting barbed portions 214 on both sides thereof. The soldering portions 213 of the first contacts 21 are arranged in a row along a horizontal direction. The contacting portions 211 are arranged in an upper and a lower row along the horizontal direction respectively.

The second contacts 22 transmits high-frequency signal. The second contacts 22 includes two pairs of differential signal contacts 221 and a grounding contact 222, all of them are arranged in accordance with USB 3.0 standard. One pair of differential signal contacts 221 is for high-frequency signal output, and another pair of differential signal contacts 221 is for high-frequency signal input. The grounding contact 222 is disposed between the two pairs of differential signal contacts 221, for reducing crosstalk in high-frequency signal transmission. Each of the second contacts 22 defines a resilient front contacting portion/section 223, a rear soldering portion/connecting section 224 and a fixing portion 225 connecting between the contacting portion 223 and the soldering portion 224. Each of the fixing portions 225 defines a pair of projecting barbed portions 226 on both sides thereof. The soldering portions 224 are arranged in a row above the soldering portions 213 of the first contacts 21 along the horizontal direction. The soldering portions 224 of the pairs of differential signal contacts 221 are outwardly deviated relative to the straight line which the corresponding contacting portion 223 extending along, for increasing the distance between adjacent soldering portions 224 of the second contacts 22.

The cable connector assembly 100 further includes a stopping member 8 assembled on the rear end of the insulative housing 1 and a front side of the spacer 4. The stopping member 8 includes a rectangular body portion 81, a plurality of projecting portions 82 forwardly extending from the body portion 81 and a plurality of spurs portions 83 projecting from an upper surface of the projecting portions 82. In the present embodiment, the stopping member 8 and the spacer 4 is provided separately, but in other embodiment, the stopping member 8 and the spacer 4 is provided integrally, it is to say the stopping member 8 can forwardly extends from the spacer 4.

The insulative housing 1 includes a first port 11 through a front surface and a rear surface thereof, a second port 12 through the front surface and a top surface thereof, and a third port 13 through the rear surface thereof to be engaged with the stopping member 8. The third port 13 is communicated with the second port 12. The projecting portions 82 of the stopping member 8 are inserted into the third port 13 along a rear-to-front direction. The projecting portions 82 of the stopping member 8 downwardly press the second contacts 22 received by the second port 12 tightly. A holding force exists between the second contacts 22, the stopper member 8, and the insulative housing 1, preventing the second contacts 22 from rearwardly backing out. Simultaneously, because of the third port 13 has no space after the second contacts 22 are inserted therein, the dielectric constant of an interval (not shown) between the second contacts 22 and the third port 13 is increased, which in turn solve the mutation problem of the mating area of the cable connector assembly 100 and a mating connector or the mutation problem of the soldering area of the contacts 2 and the cable 3. The second port 12 is disposed on a top side of the first port 11. The third port 13 is disposed behind the second port 12 and communicated with the second port 12. The first port 11 defines a plurality of first receiving slots 111 therein for receiving the first contacts 21, which are arranged on the both opposite sidewalls of the first port 11 symmetrically. The second port 12 defines a plurality of second receiving slots 121 on a bottom surface thereof, for receiving the corresponding second contacts 22. The insulative housing 1 further includes a pair of latch arm 14 rearwardly extending from the both sides thereof respectively.

The spacer 4 define a latch block 41 on each side thereof, for latching with the latch arm 14. The spacer 4 includes a base portion 42, a first holding block 43 rearwardly extending from the base portion 42, a second holding block 44 rearwardly extending from the base portion 42 and a plurality of notches 45 defined on both of the first and second holding block 43, 44. The first holding block 43 and the second holding block 44 are spaced in the vertical direction. The soldering portions 213, 224 extend to expose to the rear end of the insulative housing 1 to be received in the corresponding notches 45. A plurality of stalls 46 are defined between every two adjacent notches 35. The first holding block 43 is of U-shape, including main body 431 and an extension portion 432 extending from each side of the main body 431. Each of the extension portions 432 defines a projection 4321.

The cable connector assembly 100 further includes a printed circuit board 9 electrically connected with the first contacts 21. The pair of recessing platform 4321 holds the printed circuit board 9, preventing the printed circuit board 9 shaking, helping the welding of the cable 3 and the printed circuit board 9. Notably, this anti-vibration means may be formed on the housing instead of the spacer. The printed circuit board 9 defines a top surface 91 and an opposite bottom surface 92. The top surface 91 sets a plurality of electronic components 911 and a plurality of conductive pads 912 electrically soldered with the contacts 2 and the cable 3. The electronic components 911 are used for adjusting the voltage drop of the cable connector assembly 100.

The cable 3 includes a plurality of first wires 31 electrically connected with the printed circuit board 9 and a plurality of second wires 32 directly electrically connected with the second contacts 22.

The shielding case 6 includes an upper case 61 and a lower case 62 engaged with the upper case 61.

The cable connector assembly 100 according to the present invention includes a printed circuit board 9 electrically connected with the first contacts 21, because of the first contacts 21 is used for transmitting low-frequency signal, the printed circuit board 9 not only does not affect the transmission of high-frequency signals, but also meet customer demand for signal transmission. It is noted that in this embodiment the rear connecting sections of the second contacts are supported by the spacer in a vertical direction while the rear connecting section of the first contacts are supported by the printed circuit board in an opposite vertical direction.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A cable connector assembly comprising:
an insulative housing;
a plurality of first and second contacts retained to the insulative housing;
a spacer assembled on a rear end of the insulative housing;
a printed circuit board (PCB) electrically connected with the plurality of first contacts; and
a cable including a plurality of first wires electrically connected with the PCB and a plurality of second wires directly electrically connected with the plurality of second contacts.

2. The cable connector assembly according to claim 1, wherein the first wires and the first contacts are disposed on different sides of the PCB, respectively.

3. The cable connector assembly according to claim 1, wherein the first contacts have respective soldering portions arranged in a row along a horizontal direction.

4. The cable connector assembly according to claim 1, further comprising a stopping member assembled on the rear end of the insulative housing and at a front side of the spacer, and wherein the spacer includes a base portion and a first and second holding blocks rearwardly extending from the base portion, the first holding block and the second holding block being spaced along a vertical direction.

5. The cable connector assembly according to claim 4, wherein the first holding block is of U-shape including a main body and a respective extension portion downwardly extending from each side of the main body, each of the contacts defines a contacting portion and a soldering portion exposed to the rear end of the insulative housing, and the PCB is held and disposed between the first holding block and the soldering portions of the first contacts.

6. The cable connector assembly according to claim 5, wherein the extension portion defines a pair of inwardly projecting projections holding the PCB.

7. The cable connector assembly according to claim 6, wherein the spacer defines a plurality of notches receiving the exposed soldering portions, and a plurality of stalls between every two adjacent notches.

8. The cable connector assembly according to claim 1, wherein the insulative housing includes a pair of latch arms rearwardly extending to engage the spacer.

9. A cable connector assembly comprising:
an insulative housing;
a plurality of first contacts disposed in the housing, each of said first contacts including a first front mating section and a first rear connecting section along a front-to-back direction;
a plurality of second contacts disposed in the housing and spaced away from the first contacts in a first vertical direction perpendicular to said front-to-back direction, each of said second contacts including a second front mating section and a second rear connecting section along the front-to-back direction;
a spacer located behind the housing to regulate at least either the first rear connecting sections or the second rear connecting sections;
a printed circuit board retained at least by either the spacer or the housing;
a plurality of first wires and a plurality of second wires located behind the spacer; wherein
a front region of the printed circuit board is connected to said rear first connecting sections, the first wires are connected to a rear region of the printed circuit board, and the second wires are connected to the rear second connecting sections.

10. The cable connector assembly as claimed in claim 9, wherein said spacer is discrete from while attached to the housing.

11. The cable connector assembly as claimed in claim 10, wherein said printed circuit board is retained by the spacer.

12. The cable connector assembly as claimed in claim 9, wherein the second wires are located upon the corresponding second rear connecting sections in said first vertical direction.

13. The cable connector assembly as claimed in claim 12, wherein the first rear connecting sections are located upon the front region of the printed circuit board in a second vertical direction opposite to the first vertical direction.

14. The cable connector assembly as claimed in claim 13, wherein the first wires and the first rear connecting sections are located upon opposite surfaces of the printed circuit board.

15. The cable connector assembly as claimed in claim 14, wherein a plurality of electronic components are located upon the same surface of the printed circuit board with the first wires.

16. The cable connector assembly as claimed in claim 15, wherein the second rear connecting sections are supported by the spacer in the first vertical direction while the second rear connecting sections are supported by the printed circuit board in the second vertical direction.

17. A cable connector assembly comprising:
an insulative housing;
a plurality of first contacts disposed in the housing, each of said first contacts including a first front mating section and a first rear connecting section along a front-to-back direction;
a plurality of second contacts disposed in the housing and spaced away from the first contacts in a vertical direction perpendicular to said front-to-back direction, each of said second contacts including a second front mating section and a second rear connecting section along the front-to-back direction;
a spacer located behind the housing to regulate at least either the first rear connecting sections or the second rear connecting sections;
a printed circuit board retained by at least one of the spacer and the housing;
a plurality of first wires and a plurality of second wires located behind the spacer; wherein
the second rear connecting sections are supported by the spacer in said vertical direction while the second rear connecting sections are supported by the printed circuit board in an opposite vertical direction.

18. The cable connector assembly as claimed in claim 17, wherein the first wires are connected to the printed circuit board while the second connector are connected to the corresponding second rear connecting sections, respectively.

19. The cable connector assembly as claimed in claim 18, wherein both said first wires and said second wires are located by a same surface of the printed circuit board.

20. The cable connector assembly as claimed in claim 17, wherein said spacer is discrete from while attached to the housing.
